(19) United States
(12) Patent Application Publication
(10) Pub. No.: US 2024/0201541 A1
(43) Pub. Date: Jun. 20, 2024

(54) LIQUID CRYSTAL DISPLAY DEVICE, AND A METHOD OF MANUFACTURING THE SAME

(71) Applicant: National Cheng Kung University, Tainan City (TW)

(72) Inventors: Chun-Yen Liu, Tainan City (TW); Jui-Hsiang Liu, Tainan City (TW)

(73) Assignee: National Cheng Kung University, Tainan City (TW)

(21) Appl. No.: 18/172,872

(22) Filed: Feb. 22, 2023

(30) Foreign Application Priority Data
Dec. 20, 2022 (TW) 111148974

(51) Int. Cl. G02F 1/1337; C09K 19/36; C09K 19/54; C09K 19/56; G02F 1/1334

(52) U.S. Cl. CPC G02F 1/13378; C09K 19/36; C09K 19/542; C09K 19/56; G02F 1/13345; G02F 1/133742; G02F 1/137

(57) ABSTRACT

The present invention provides a liquid crystal display device, which comprises: cholesteric liquid crystals and polymer fragments. By adding polymer fragments, the upper and lower substrates of the liquid crystal display device of the present invention may control the alignment of the liquid crystals and have excellent electro-optical characteristics without the use of an alignment film; furthermore, the polymer fragments are modified with a vertical alignment agent, DMOAP to form a radial structure so as to improve the contrast. The present invention also provides a method for preparing a liquid crystal display device in a simple way, so that the liquid crystal display device has the electro-optical characteristics of high contrast, low threshold voltage, and fast response time.

### CROSS-REFERENCE TO RELATED APPLICATIONS

This application claims the benefit of priority of Taiwan Application Number TW111148974, filed Dec. 20, 2022, which is herein incorporated by reference in its entirety.

### TECHNICAL FILED

The present invention relates to a liquid crystal display device and a method of manufacturing the same, particularly a cholesteric liquid crystal display device with polymer fragments and a method of manufacturing the same.

### BACKGROUND

From black-and-white images to fantastic colorful patterns, liquid crystal display devices are broadly applied in indoor digital devices, advertising boards or car navigation systems among others due to their excellent sensitivity and unique electro-optical response.

Generally, a layer of alignment layer has to be coated on the liquid crystal substrate of traditional liquid crystal display device s to control the direction of the liquid crystals to achieve liquid crystal displays controlled by voltage. However, the step of coating an alignment layer will make the manufacturing process of liquid crystal display devices more complicated, force the production cost to increase, and decrease the brightness of the display due to the increase of the coating layer. These are all disadvantages for liquid crystal display devices.

Furthermore, in the prior art, to improve the performance of liquid crystal display devices, polymers are often used as the matrix or added to form a network in liquid crystal materials to produce polymer-liquid crystal composites, which are called, for example, polymer-dispersed liquid crystals for those having high contents of polymers or polymer-stabilized liquid crystals for those having low contents of polymers, and they all show more stable properties than pure liquid crystals.

Despite that there has been plenty of studies about liquid crystal display devices so far, related industry still desires liquid crystal display devices with an easier manufacturing process, lower cost, better brightness and contrast, excellent electro-optical characteristics and high response speed.

### SUMMARY

Accordingly, the present invention provides a liquid crystal display device and a method of manufacturing the same for the purpose of providing a liquid crystal display device which does not have to be coated with an alignment layer to simplify the manufacturing process and reduce cost, and provides a liquid crystal display device with better brightness and contrast, excellent electro-optical characteristics and high response speed.

Accordingly, the present invention adds polymer fragments in cholesteric liquid crystals to disturb the alignment of the arrangement of the liquid crystals so that the alignment of the liquid crystals may also be controlled in the liquid crystal display device without an alignment layer.

Also, the present invention can make the liquid crystal display device added with polymer fragments more stabilized, for example, when adding polymer matrix into liquid crystals, by the strong interaction generated between the polymer matrix and the liquid crystals; or, when adding liquid crystal crosslinkable monomers, monomers and photoinitiator to cause the polymers to polymerize again, by the strong interaction generated between the polymerized polymers and the liquid crystals; and thereby leads to steric disturbing effect and enhances the contrast of the liquid crystal display device.

Furthermore, the present invention uses dimethyloctadecyl-3-(trimethoxysilyl) propyl ammonium chloride (DMOAP) to surface-modify the polymer fragments to form radial construction on the surface of the polymer fragments and thereby interact with the alignment of surrounding liquid crystals. Due to the radial construction, the DMOAP-treated polymer fragments show stronger steric disturbing effect to surrounding liquid crystals, which thereby results in an increase in the contrast and a decrease in the response time of the liquid crystal arrangement.

Also, the polymer fragments added in the present invention can have optical activity and thereby can effectively improve the electro-optical performances based on the chiral effect of the optically active materials on the liquid crystal molecules.

Specifically, an aspect of the present invention is a liquid crystal display device comprising: cholesteric liquid crystals, and polymer fragments.

In some embodiments, the polymer fragments comprise at least one selected from a polymer particle and a rod-like polymer particle.

In some embodiments, the polymer fragments are surface-modified with a vertical alignment agent, DMOAP.

In some embodiments, the liquid crystal display device is stabilized by a polymer network.

In some embodiments, the polymer fragments have optical activity.

In some embodiments, the contrast of the liquid crystal display device is 60.0% and above, preferably 61.2%-97.4%, more preferably 80-97.4%.

In some embodiments, the response time of the liquid crystal display device is 30 ms and below, preferably 13 ms and below, more preferably 7 ms and below.

Another aspect of the present invention is a method of manufacturing the liquid crystal display device, comprising:
a step of preparing the cholesteric liquid crystals by doping a commercially available nematic liquid crystals MJ05681 with a CB15 optically active liquid crystal compound to form a cholesteric liquid crystal mixture; and
a step of preparing the liquid crystal display device, comprising dispersing the polymer fragments in a solvent (e.g., chloroform) to form dispersions; dropping the dispersions into the cholesteric liquid crystal mixture; dropping a few drops of the solvent into the mixture and stirring well; heating the mixture for homogenization and then removing the solvent; and injecting the mixture into an ITO cell.

Another aspect of the present invention is a method of manufacturing the liquid crystal display device, comprising:
a step of preparing the cholesteric liquid crystals by doping a commercially available nematic liquid crystals MJ05681 with a CB15 optically active liquid crystal compound to form a cholesteric liquid crystal mixture;
a step of vertical surface modification of the polymer fragments with the DMOAP, comprising adding a DMOAP solution to the polymer fragments; and
reacting by ultrasonically oscillating the polymer fragments, followed by centrifuging with deionized water to perform surface modification, freeze-drying and grounding the surface modified polymer fragments;
and a step of preparing the liquid crystal display device, comprising: dispersing the polymer fragments that are surface-modified with the DMOAP in a solvent (e.g., chloroform) to form dispersions; dropping the dispersions into the cholesteric liquid crystal mixture; dropping a few drops of the solvent into the mixture and stirring well; heating the mixture for homogenization and then removing the solvent; and injecting the mixture into an ITO cell.

Furthermore, another aspect of the present invention is a method of manufacturing the polymer-stabilized liquid crystal display device, comprising: a step of preparing the cholesteric liquid crystals by doping a commercially available nematic liquid crystals MJ05681 with a CB15 optically active liquid crystal compound to form a cholesteric liquid crystal mixture;
a step of polymer stabilization by dropping liquid crystal crosslinkable monomers, monomers, a photoinitiator and a few drops of chloroform into the cholesteric liquid crystal mixture;
and a step of preparing the liquid crystal display device, comprising: dispersing the polymer fragments in a solvent (e.g., chloroform) to form dispersions; dropping the dispersions into the polymer-stabilized cholesteric liquid crystal mixture; dropping a few drops of the solvent into the mixture and stirring well; heating the mixture for homogenization and then removing the solvent; and injecting the mixture into an ITO cell and polymerizing polymer network.

The liquid crystal display device of the present invention does not have to be coated with an alignment layer and can control the alignment of liquid crystals by merely adding polymer fragments. Therefore, the present invention can simplify the manufacturing process, reduce production cost and enhance the display brightness.

The liquid crystal display device of the present invention effectively improves the electro-optical performances of the liquid crystal display device by adding polymer fragments with optical activity.

Furthermore, the present invention stabilizes the liquid crystal display device with polymer by adding polymer matrix or liquid crystal crosslinkable monomers and a photoinitiator. The steric disturbing effect generated between the polymer matrix or polymerized polymers and liquid crystals is utilized to enhance contrast and achieve a contrast of 60.0% and above, preferably 61.2%-97.4%, more preferably 80-97.4%. Accordingly, the liquid crystal display device of the present invention can be easily combined with color films and display vivid, rich and colorful images.

Furthermore, the liquid crystal display device of the present invention allows the surface of the polymer fragments to form radial construction by DMOAP and affects the arrangement of liquid crystals. Therefore, the present invention can enhance contrast, reduce the response time of the liquid crystal arrangement, and achieve high-speed responsive liquid crystal display device with excellent electro-optical performances and short response time, wherein the response time is 30 ms and below, preferably 13 ms and below, more preferably 7 ms and below.

The liquid crystal display device of the present invention can be applied broadly, including liquid crystal display device, smart windows, field sequential color liquid crystal display device, bistable liquid crystal display device, among others, due to its excellent performances and high stability.

### BRIEF DESCRIPTION OF THE DRAWINGS

FIG. 1 represents the schematic diagram of a general conventional liquid crystal display device.

FIG. 2 represents the schematic diagram of the liquid crystal arrangement of the liquid crystal display device of the present invention added with polymer fragments when an electric field is applied or not applied.

FIG. 3 represents the radial construction of the polymer fragments modified with a vertical alignment agent, DMOAP.

FIG. 4 represents the schematic diagram of the liquid crystal arrangement of the liquid crystal display device of the present invention added with polymer fragments modified with the vertical alignment agent, DMOAP when an electric field is applied or not applied.

FIG. 5 represents the transparent state of the liquid crystal display device of the present invention when an electric field is applied (On) and the opaque state thereof when an electric field is not applied (Off).

FIG. 6 represents devices for measuring the electro-optical characteristics of the liquid crystal display device of the present invention.

FIG. 7 represents the POM images of the liquid crystal display device of the present invention when an electric field is applied.

FIG. 8 represents the POM images of the liquid crystal display device of the present invention when an electric field is not applied.

FIG. 9 represents the schematic diagram of how to calculate the response time.

FIG. 10 represents the results of measuring the stability of the liquid crystal display device of Example 14.

FIG. 11 represents the results of measuring the stability of the liquid crystal display device of Example 23.

### DETAILED DESCRIPTION

The purpose of the present invention is to provide a liquid crystal display device and a method of manufacturing the same. The liquid crystal display device does not have to be coated with an alignment layer, is able to simplify the manufacturing process, reduce cost and has excellent properties: great brightness of display and contrast, excellent electro-optical characteristics, high response speed and high stability.

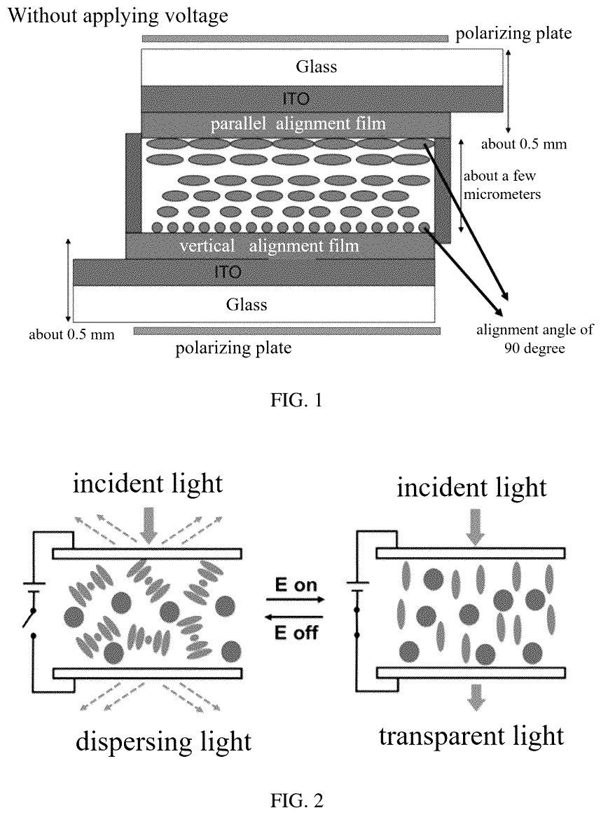

As shown in FIG. 1, a general conventional liquid crystal display device has to be provided with an alignment film to control the arrangement of the liquid crystals.

Accordingly, as shown in FIG. 2, the present invention allows the arrangement of the liquid crystals to be controlled without an alignment layer in the liquid crystal display device by adding polymer fragments into cholesteric liquid crystals to disturb the alignment of the arrangement of the liquid crystals. Specifically, when an electric field is not applied (Off), the liquid crystals are in a focal conic state and scattering arrangement, showing an opaque appearance. When an electric field is applied (On), the helices of cholesteric liquid crystals were forced to be unwound and liquid crystals are aligned in homeotropic alignment, showing a transparent state. Once the applied electric field disappears, the arrangement of liquid crystals will be affected by the doped polymer fragments again and restore to an opaque focal conic state and scattering arrangement.

Also, the polymer fragments added by the present invention can have optical activity and allow the liquid crystal materials to form chiral cholesteric liquid crystals with stronger chirality and have better chiral construction. Thus, the present invention adds polymer fragments with optical activity into liquid crystals, which can allow the liquid crystal display device to have the display function of controlling the liquid crystal display device to be transparent or opaque as previously described. Also, adding optically active substances allows the liquid crystal display device to have even more excellent electro-optical characteristics.

Also, adding polymer matrix or liquid crystal crosslinkers, a photoinitiator and chloroform to make the liquid crystal display device polymer-stabilized can enhance contrast of the display by the steric disturbing effect generated between the polymer matrix or polymerized polymers and liquid crystals.

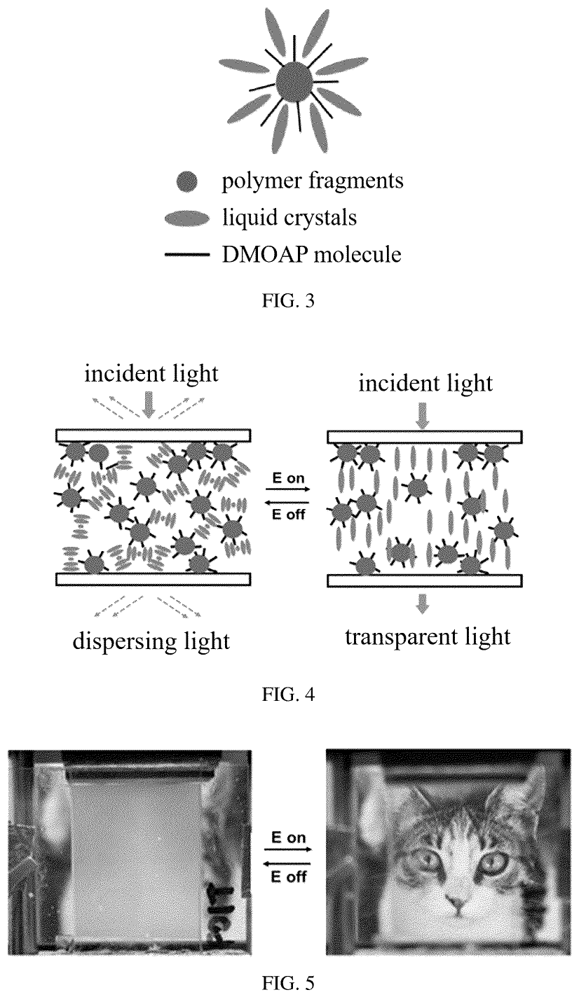

Also, to further enhance the disturbance of the polymer fragments, the present invention modifies the polymer fragments with the vertical alignment agent, DMOAP, which allows the polymer fragments to form radially oriented radial structure, as shown in FIG. 3, and can further enhance its effects on the arrangement of liquid crystals.

Thereby, as shown in FIG. 4, for the liquid crystal display device added with the polymer fragments modified with the vertical alignment agent, DMOAP, when an electric field is applied (On), the helices of cholesteric liquid crystals were forced to be unwound, liquid crystals are aligned in homeotropic alignment, and the incident light will pass through the liquid crystal display device, which makes it transparent. When the electric field disappears (Off), the liquid crystal display device will show random light and an opaque appearance in a focal conic state and scattering arrangement because of the disturbance of polymer fragments with radial construction.

FIG. 5 is the transparent state of the liquid crystal display device when an electric field is applied (On) and the opaque state thereof when an electric field is not applied (Off), wherein the cat image shown in the background can be seen in the transparent state. The present invention uses DMOAP to form radial construction on the surface of polymer fragments and interact with the arrangement of the surrounding liquid crystals, which can increase the contrast and decrease the response time.

The present invention will be explained through the following Examples. The Examples of the present invention are not intended to limit the present invention to be implemented in accordance with any specific conditions, applications or specific methods described in the Examples. Thus, the illustration of Examples is only for the purpose of explaining the present invention and not intended to limit the present invention.

Specifically, polydopamine particles (PDA particles) are used as example of polymer fragments in Examples of the present invention, but not limited thereto. For example, rod-like polymer particles or other triangular, circular, amorphous particles can also be used as added polymer fragments. They can also disturb the alignment of arrangement of liquid crystals to achieve the effects of the present invention. Likewise, optically active cellulose particles are used as example of polymer fragments with optically activity, but also not limited thereto. All polymer fragments with optically activity such as nanofiber tubes, functionalized carbon nanotubes or any synthesized polymer particles with optically activity can also achieve the effects of the present invention. Also, the present invention added liquid crystal crosslinkers, a photoinitiator and chloroform to form polymer network for stabilizing, but also not limited thereto. All steps that can make liquid crystal display device further polymer-stabilized can also achieve the effects of the present invention. For example, adding 0.01 wt %-5 wt % polymer stabilizing network or adding 5 wt %-30 wt % polymer dispersing network.

### [Drugs and Instruments]

All the commercial chemicals used in the present invention are ACS grade or higher and were used without further purification, wherein MJ05581 (US022), CB 15 optical active liquid crystal compound, HCM008 (RM257), and Irgacure-184 were purchased from Merck, Fusol Material Corp., Luminescence Technology Corp. and Alfa Aesar, respectively. 3-Hydroxytyramine hydrochloride (dopamine hydrochloride) and DMOAP were purchased from Acros Organics. ITO glass and spacers were purchased from Uni-onward Corp. and Shinkong Synthetic Fibers Corp. Optically active nanofibers, Cellulose nanocrystals, Desulfated (CNC-DS), were purchased from Cellulose Lab.

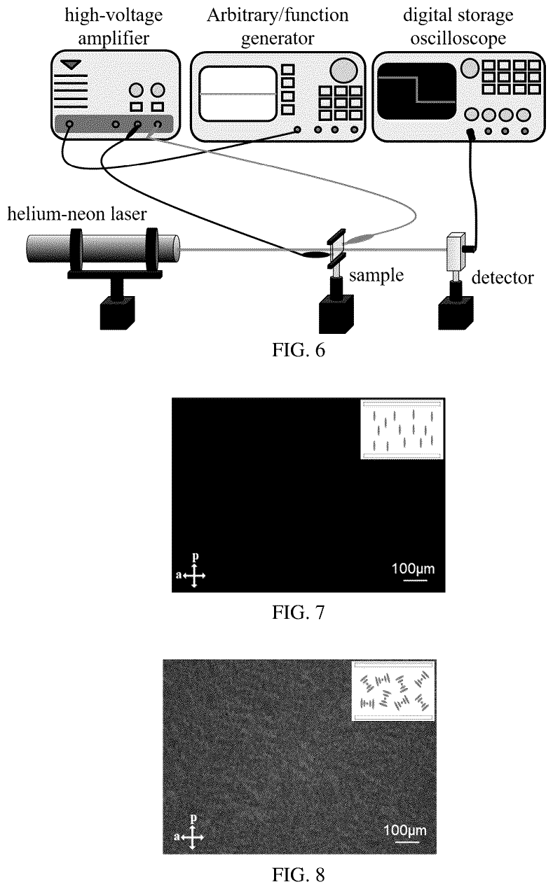

As shown in FIG. 6, the electro-optical properties of the liquid crystal display device of the present invention were estimated using a setup consisting of the following parts: Arbitrary/function generator: Tektronix AFG3021B; digital storage oscilloscope: Tektronix TDS 2014b; high-voltage amplifier: HA-805; photodetector: Electro-Optics Technology ET-2000 Silicon Pin Detector; and helium-neon laser: Meredith Instruments, Box 1724, Glendale, AZ 85301. Also, an Olympus BH-2 polarized light microscope (POM) equipped with a Mettler FP-82 hot stage with a temperature scanning rate of 10 K/min was used for measurement.

### EXAMPLES

### [Preparation of Liquid Crystal Display Device]

### 1. Preparing PDA Particles

Dopamine hydrochloride (0.2 g) was dissolved in 16 ml of ethanol and 40 ml of deionized water. NaOH was used to adjust the pH value to 10. The mixture was stirred at 300 rpm at 30° C. for 24 h. The synthesized PDA was separated by operating a rotary separator at 6000 rpm for 10 minutes. PDA was washed with deionized water by centrifuging at 6000 rpm three times. The prepared PDA were dried in an oven for 2 days and ground to form dispersed PDA particles for use.

2. Modifying the Surface of PDA Particles to Prepare PDAT Particles with Radial Construction

DMOAP was used for surface-modification in this step. The prepared PDA were immersed in a large amount of 1.5 wt % DMOAP solution. The mixture was treated under ultrasonic oscillation for 20 minutes and then washed with deionized water by centrifuging at 6000 rpm three times. The mixture was then freeze-dried for 2 days to obtain polymer particles which were then ground and dispersed to form PDAT particles.

3. Preparing Optically Active Cellulose Particles (CT Particles) with Radial Construction

Add 1.25 g DMOAP and 0.3 g commercially available cellulose nanoparticles (CN particles) into 50 ml deionized water. After ultrasonic oscillation of 20 minutes, wash the mixture with deionized water three times. The mixture was then ground and dried to form CT particles.

### 4. Manufacturing ITO Cells

The ITO-coated glass substrates (i.e., ITO glass) were cut into 25 mm×25 mm squares with a thickness of 0.7 mm. The substrates were washed for 15 min in an ultrasonic cleaner and then washed with deionized water two times, each time for 15 min. Acetone was used to wash the substrates in oscillation for 30 min. The substrates were then dried in an oven for at least 2 hours.

Then, one ITO glass was overlapped face-to-face with another ITO glass. The overlapped area was 21 mm×17 mm. The gap of the cell was determined by spacers that were placed between the two ITO glasses. The present invention used spacers with a thickness of 25 m and a size of 18 mm×2 mm. Also, the edges of the assembled ITO cells were enclosed with epoxy glue. Last, dry the ITO cells for 2 days.

### 5. Preparing Cholesteric Liquid Crystal Mixture

The commercially available nematic liquid crystals MJ05581 were doped with 5 wt % CB15 optically active liquid crystal compound to form a cholesteric liquid crystal mixture.

### 6. Preparing Liquid Crystal Display Device

### {Examples 1-7}—Liquid Crystal Display Device Added with PDA Particles or PDAT Particles

The prepared PDA particles or PDAT particles were dispersed in chloroform respectively to form homogeneous dispersions. After ultrasonic oscillation for 10 min, the dispersion was immediately dropped into the prepared cholesteric liquid crystal mixture. As shown in Table 1, the concentration of PDA particles or PDAT particles dispersed in the cholesteric liquid crystal mixtures was adjusted to be in the range of 0.05-0.2 wt %. Then, a few drops of chloroform were dropped into the mixtures and stirred at 300 rpm for 2 days to prepare homogeneous liquid crystal mixtures. After removing the chloroform solvent, the prepared homogeneous liquid crystal mixtures were ultrasonically oscillated for 10 min to prevent the aggregation of particles.

TABLE 1

| | | Cholesteric | PDA | PDAT |
|---|---|---|---|---|
| | | liquid crystal | particles | particles |
| | Name | mixture (wt %) | (wt %) | (wt %) |
| Example 1 | CLC | 100 | 0 | 0 |
| Example 2 | D05 | 99.95 | 0.05 | 0 |
| Example 3 | D1 | 99.90 | 0.10 | 0 |
| Example 4 | D2 | 99.80 | 0.20 | 0 |
| Example 5 | D05T | 99.95 | 0 | 0.05 |
| Example 6 | D1T | 99.90 | 0 | 0.10 |
| Example 7 | D2T | 99.80 | 0 | 0.20 |

Note:
Examples 2-4 are liquid crystal display devices added with PDA particles while Examples 5-7 are liquid crystal display devices added with PDAT particles.

Then, the oscillated liquid crystal mixture was heated to the isotropic phase which was approximately 75° C. and injected into the prepared ITO cell via capillary action to form a liquid crystal display device. To confirm it was sufficiently homogenized, the cell was kept at 75° C. for 10 min. Afterward, the prepared liquid crystal display device was removed from the hot plate and gradually cooled to room temperature.

### {Examples 8-14}—Polymer-Stabilized Liquid Crystal Display Device with PDA Particles or PDAT Particles

2 wt % RM257 liquid crystal crosslinker, 0.4 wt % IRG184 photoinitiator and a few drops of chloroform were dropped into the prepared cholesteric liquid crystal mixture to form processed cholesteric liquid crystal mixture. As shown in Table 2, the concentration of PDA particles or PDAT particles dispersed in the processed cholesteric liquid crystal mixtures was adjusted to be in the range of 0.05-0.2 wt %.

TABLE 2

| | | Processed | PDA | PDAT |
|---|---|---|---|---|
| | | cholesteric liquid | particles | particles |
| | Name | crystals mixture (wt %) | (wt %) | (wt %) |
| Example 8 | PSCLC | 100 | 0 | 0 |
| Example 9 | PD05 | 99.95 | 0.05 | 0 |
| Example 10 | PD1 | 99.90 | 0.10 | 0 |
| Example 11 | PD2 | 99.80 | 0.20 | 0 |
| Example 12 | PD05T | 99.95 | 0 | 0.05 |
| Example 13 | PD1T | 99.90 | 0 | 0.10 |
| Example 14 | PD2T | 99.80 | 0 | 0.20 |

Note:
Examples 9-11 are polymer-stabilized liquid crystal display devices with PDA particles while Examples 12-14 are polymer-stabilized liquid crystal display devices with PDAT particles.

Then, the oscillated liquid crystal mixture was heated to the isotropic phase which was approximately 75° C. and injected into the prepared ITO cell via capillary action to form a liquid crystal display device. To confirm it was sufficiently homogenized, the cell was kept at 75° C. for 10 min. Afterward, the prepared liquid crystal display device was removed from the hot plate and gradually cooled to room temperature. Then, an electric voltage of 40 V was applied across the cell and then the cell was exposed to UV irradiation (365 nm, 5 mW/cm²) for 3 min to form polymer-stabilized liquid crystal display devices with PDA particles or PDAT particles.

### {Examples 15-21}—Liquid Crystal Display Device Added with CN Particles or CT Particles

The prepared CN particles or CT particles were dispersed in chloroform respectively to form dispersions. After ultrasonic oscillation for 10 min, the dispersion was immediately dropped into the prepared cholesteric liquid crystal mixture. As shown in Table 3, the concentration of CN particles or CT particles dispersed in the cholesteric liquid crystal mixtures was adjusted to be in the range of 0.05-0.2 wt %. Then, a few drops of chloroform were dropped into the mixtures and stirred at 300 rpm for 2 days to prepare homogeneous liquid crystal mixtures. After removing the solvent, the prepared homogeneous liquid crystal mixtures were ultrasonically oscillated for 10 min to prevent the aggregation of particles.

TABLE 3

| | | Cholesteric | CN | CT |
|---|---|---|---|---|
| | | liquid crystal | particles | particles |
| | Name | mixture (wt %) | (wt %) | (wt %) |
| Example 15 | CLC | 100 | 0 | 0 |
| Example 16 | C05 | 99.95 | 0.05 | 0 |
| Example 17 | C1 | 99.90 | 0.10 | 0 |
| Example 18 | C2 | 99.80 | 0.20 | 0 |
| Example 19 | C05T | 99.95 | 0 | 0.05 |
| Example 20 | C1T | 99.90 | 0 | 0.10 |
| Example 21 | C2T | 99.80 | 0 | 0.20 |

Note:
Examples 16-18 are liquid crystal display devices added with CN particles while Examples 19-21 are liquid crystal display devices added with CT particles.

Then, the oscillated liquid crystals mixture was heated to the isotropic phase which was approximately 75° C. and injected into the prepared ITO cell via capillary action to form a liquid crystal display device. To confirm it was sufficiently homogenized, the cell was kept at 75° C. for 10 min. Afterward, the prepared liquid crystal display device was removed from the hot plate and gradually cooled to room temperature.

### {Examples 22-28}—Polymer-Stabilized Liquid Crystal Display Device with CN Particles or CT Particles

2 wt % RM257 liquid crystal crosslinker, 0.4 wt % IRG184 photoinitiator and a few drops of chloroform were dropped into the prepared cholesteric liquid crystal mixture to form processed cholesteric liquid crystal mixture. As shown in Table 4, the concentration of CN particles or CT particles dispersed in the processed cholesteric liquid crystal mixtures was adjusted to be in the range of 0.05-0.2 wt %.

TABLE 4

| | | Processed | CN | CT |
|---|---|---|---|---|
| | | cholesteric liquid | particles | particles |
| | Name | crystal mixture (wt %) | (wt %) | (wt %) |
| Example 22 | PSCLC | 100 | 0 | 0 |
| Example 23 | PC05 | 99.95 | 0.05 | 0 |
| Example 24 | PC1 | 99.90 | 0.10 | 0 |
| Example 25 | PC2 | 99.80 | 0.20 | 0 |
| Example 26 | PC05T | 99.95 | 0 | 0.05 |
| Example 27 | PC1T | 99.90 | 0 | 0.10 |
| Example 28 | PC2T | 99.80 | 0 | 0.20 |

Note:
Examples 23-25 are polymer-stabilized liquid crystal display devices with CN particles while Examples 26-28 are polymer-stabilized liquid crystal display devices with CT particles.

Then, the oscillated liquid crystal mixture was heated to the isotropic phase which was approximately 75° C. and injected into the prepared ITO cell via capillary action to form a liquid crystal display device. To confirm it was sufficiently homogenized, the cell was kept at 75° C. for 10 min. Afterward, the prepared liquid crystal display device was removed from the hot plate and gradually cooled to room temperature. Then, an electric voltage of 40 V was applied across the cell and then the cell was exposed to UV irradiation (365 nm, 5 mW/cm²) for 3 min to form polymer-stabilized liquid crystal display device with PDA particles or PDAT particles.

### [Results Analysis]

### {Impact on Arrangement of Liquid Crystals}

The morphology of PC05 liquid crystal display of Example 23 with or without an applied electric field at DC voltage of 40V was measured with POM. The results are as shown in FIG. 7 and FIG. 8. In FIG. 7, when an electric field was applied, the liquid crystals were in perpendicular alignment and showed dark image under POM. By contrast, in FIG. 8, when an electric field was not applied, the liquid crystals were in a focal conic state and scattering arrangement and therefore showed color image under POM. Accordingly, it is apparent that the present invention can effectively change the arrangement of liquid crystals by adding polymer fragments and the substrate does not have to be coated with an alignment layer.

### {Contrast}

The measured contrast of the liquid crystal display device of each Example of the present invention at DC voltage of 40V, switching voltage is shown in Tables 5-8.

1. Liquid Crystal Display Added with PDA Particles or PDAT Particles

TABLE 5

| | Name | Contrast (%) |
|---|---|---|
| Example 1 | CLC | 3.4 |
| Example 2 | D05 | 65.8 |
| Example 3 | D1 | 42.1 |
| Example 4 | D2 | 34.7 |
| Example 5 | D05T | 3.9 |
| Example 6 | D1T | 20.6 |
| Example 7 | D2T | 61.2 |

Note:
Examples 2-4 are liquid crystal display devices added with PDA particles while Examples 5-7 are liquid crystal display devices added with PDAT particles.

As shown in Table 5, without any polymer particles, the liquid crystal display device shows only a contrast of 3.4%. However, with PDA particles or PDAT particles, the liquid crystal display device can also control the arrangement of liquid crystals without an alignment layer because the arrangement of cholesteric liquid crystals was impacted by the added particles. Thus, the contrast can be increased to 65.8%.

Also, as the concentration of PDA particles increased, the contrast of the liquid crystal display device decreased drastically, which results from the fact that a high concentration of PDA particles may aggregate and cause a decrease in contrast. However, as long as the polymer fragments are added, the contrast of the liquid crystal display device can be improved to achieve the effect of the present invention. Furthermore, the liquid crystal display devices added with PDA particles or PDAT particles can reach a contrast of 60.0% and above by adjusting the appropriate concentration of added particles.

2. Polymer-Stabilized Liquid Crystal Display Device with PDA Particles or PDAT Particles

TABLE 6

| | Name | Contrast (%) |
|---|---|---|
| Example 8 | PSCLC | 17.2 |
| Example 9 | PD05 | 66.9 |
| Example 10 | PD1 | 70.6 |
| Example 11 | PD2 | 53.1 |
| Example 12 | PD05T | 51.8 |
| Example 13 | PD1T | 10.4 |
| Example 14 | PD2T | 93.6 |

Note:
Examples 9-11 are polymer-stabilized liquid crystal display devices with PDA particles while Examples 12-14 are polymer-stabilized liquid crystal display devices with PDAT particles.

As shown in Table 6, without any polymer particles, the liquid crystal display device shows only a contrast of 17.2%. With PDA particles or PDAT particles, the highest contrast can reach 93.6%. The excellent contrast indeed represents the utility of the liquid crystal display device in industry.

Specifically, for the polymer-stabilized liquid crystal display device with PDA particles or PDAT particles, besides the increase in contrast resulted from the interaction between polymer matrix and liquid crystals, it is apparent based on the results that adding the PDA particles or PDAT particles as polymer fragments of the present invention further disturbs the arrangement of cholesteric liquid crystals and thereby increases the highest contrast. However, if more than a certain amount of PDA particles or PDAT particles is added, particle aggregation as mentioned may also occur, resulting in a slight decrease in contrast. The improvement of contrast depends on the concentration of added polymer fragments. However, as long as the polymer fragments are added, the contrast of the liquid crystal display device is mostly improved, which achieves the effect of the present invention.

3. Liquid Crystal Display Device Added with CN Particles or CT Particles

TABLE 7

| | Name | Contrast (%) |
|---|---|---|
| Example 15 | CLC | 3.4 |
| Example 16 | C05 | 23.2 |
| Example 17 | C1 | 34.9 |
| Example 18 | C2 | 96.9 |
| Example 19 | C05T | 87.7 |
| Example 20 | C1T | 66.6 |
| Example 21 | C2T | 29.5 |

Note:
Examples 16-18 are liquid crystal display devices added with CN particles while Examples 19-21 are liquid crystal display devices added with CT particles.

As shown in Table 7, without any polymer particles, the liquid crystal display device shows only a contrast of 3.4%. With the optically active CN particles and CT particles, the highest contrast can reach 96.9%. The excellent contrast indeed represents the utility of the liquid crystal display device in industry. The improvement of contrast depends on the concentration of added polymer fragments. However, as long as the polymer fragments are added, the contrast of the liquid crystal display device can be improved to achieve the effect of the present invention.

4. Polymer-Stabilized Liquid Crystal Display Device with CN Particles or CT Particles

TABLE 8

| | Name | Contrast (%) |
|---|---|---|
| Example 22 | PSCLC | 17.2 |
| Example 23 | PC05 | 97.4 |
| Example 24 | PC1 | 38.6 |
| Example 25 | PC2 | 61.4 |
| Example 26 | PC05T | 30.1 |
| Example 27 | PC1T | 79.9 |
| Example 28 | PC2T | 84.9 |

Note:
Examples 23-25 are polymer-stabilized liquid crystal display devices with CN particles while Examples 26-28 are polymer-stabilized liquid crystal display devices with CT particles.

As shown in Table 8, without any polymer particles, the liquid crystal display device shows only a contrast of 17.2%. With the optically active CN particles and CT particles, the highest contrast can reach 97.4%. The excellent contrast indeed represents the utility of the liquid crystal display device in industry. The improvement of contrast depends on the concentration of added polymer fragments. However, as long as the polymer fragments are added, the contrast of the liquid crystal display device can be improved to achieve the effect of the present invention.

### {Response Time}

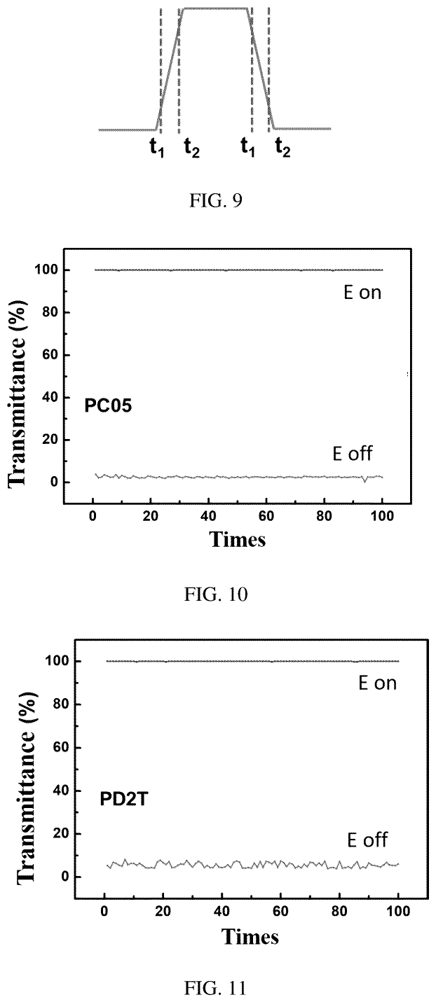

Response time means the speed at which the liquid crystal display device responds to an input signal, that is, the time which turn-on or turn-off takes when voltage is applied in liquid crystal molecules to twist and recover the liquid crystal molecules. Shorter response time means less afterimages occur when users are watching dynamic images. It is calculated as shown in FIG. 9 and the following formula:

response time=|t1−t2|

t1 is the time when transmittance changes for 10% and t2 is the time when transmittance changes for 90%.

Table 9 shows the results of turn-on and turn-off response time of Example 1, Example 8, Example 14, Example 20, Example 28 respectively.

TABLE 9

| | | Turn-on | Turn-off | |
|---|---|---|---|---|
| | | response time | response time | Average |
| | Name | (ms) | (ms) | (ms) |
| Example 1 | CLC | 36.4 | 12.0 | 24.2 |
| Example 8 | PSCLC | 150.0 | 12.4 | 81.2 |
| Example 14 | PD2T | 16.8 | 9.2 | 13.0 |
| Example 20 | C1T | 0.3 | 15.1 | 7.7 |
| Example 28 | PC2T | 49.0 | 11.0 | 30.0 |

Note:
Example 14 is a polymer-stabilized liquid crystal display device with PDAT particles; Example 20 is a liquid crystal display device with CT particles; and Example 28 is a polymer-stabilized liquid crystal display device with CT particles.

It is noted that the response time is demanded to be shorter than the time of visual persistence of humans, i.e., 62.5 milliseconds. Compared to Example 1 and Example 8 that are without polymer fragments, the liquid crystal display device of the present invention satisfies the demand for the response time to be far shorter than the time of visual persistence of humans through Example 14, Example 20, and Example 28, which are added with polymer fragments or added with polymer fragments and stabilized at the same time. Accordingly, the liquid crystal display device of the present invention manufactured by adding polymer fragments or by adding polymer fragments and stabilizing at the same time can be applied to various dynamic images and is suitable for the design of television screens.

### {Stability}

FIG. 10 and FIG. 11 represent the measured stability of the liquid crystal display device of Example 14 and Example 23. The results demonstrated that the polymer-stabilized liquid crystal display device with polymer fragments still showed stable transmittance performance after 100 cycles at DC voltage of 40V. Accordingly, it can be known that the polymer-stabilized liquid crystal display device of the present invention indeed has high stability and is suitable for broad application.

In summary, the liquid crystal display device of the present invention which does not have to be coated with an alignment layer can simplify the manufacturing process, reduce cost, and has excellent properties: great brightness of display and contrast, excellent electro-optical characteristics, high response speed and high stability, and can be applied broadly, including liquid crystal display devices, smart windows, field sequential color liquid crystal display devices, and bistable liquid crystal display devices, among others.

1. A liquid crystal display device comprising:
cholesteric liquid crystals, and polymer fragments,
wherein the polymer fragments are dispersed in the liquid crystal display device.

2. The liquid crystal display device of claim 1, wherein the polymer fragments comprise at least one of a rod-like polymer particle, a circular polymer particle, a triangular polymer particle or an amorphous polymer particle.

3. The liquid crystal display device of claim 1, wherein the polymer fragments are surface-modified with a vertical alignment agent, and the vertical alignment agent is dimethyloctadecyl-3-(trimethoxysilyl) propyl ammonium chloride (DMOAP).

4. The liquid crystal display device of claim 1, wherein the liquid crystal display device is stabilized by a polymer network.

5. The liquid crystal display device of claim 1, wherein the polymer fragments have optical activity.

6. A method of manufacturing the liquid crystal display device of claim 1, comprising:
a step of preparing the cholesteric liquid crystals by doping a nematic liquid crystal with an optically active compound to form a cholesteric liquid crystal mixture; and
a step of preparing the liquid crystal display device, comprising:
dispersing the polymer fragments in a solvent to form dispersions;
dropping the dispersions into the cholesteric liquid crystal mixture;
dropping a few drops of the solvent into the mixture and stirring well;
heating the mixture for homogenization and then removing the solvent; and
injecting the mixture into an ITO cell.

7. A method of manufacturing the liquid crystal display device of claim 3, comprising:
a step of preparing the cholesteric liquid crystals by doping a nematic liquid crystal with an optically active compound to form a cholesteric liquid crystal mixture;
a step of vertical surface modification of the polymer fragments with the DMOAP, comprising:
adding a DMOAP solution to the polymer fragments; and
ultrasonically oscillating the polymer fragments, followed by centrifuging, freeze-drying and grounding the polymer fragments;
and a step of preparing the liquid crystal display device, comprising:
dispersing the polymer fragments that are surface-modified with the DMOAP in a solvent to form dispersions;
dropping the dispersions into the cholesteric liquid crystal mixture;
dropping a few drops of the solvent into the mixture and stirring well;
heating the mixture for homogenization and then removing the solvent; and
injecting the mixture into an ITO cell.

8. A method of manufacturing the liquid crystal display device of claim 4, comprising:
a step of preparing the cholesteric liquid crystals by doping a nematic liquid crystal with an optically active compound to form a cholesteric liquid crystal mixture;
a step of polymer stabilization by dropping a liquid crystal crosslinker, monomers, a photoinitiator and a few drops of a solvent into the cholesteric liquid crystal mixture;
and a step of preparing the liquid crystal display device, comprising:
dispersing the polymer fragments in a solvent to form dispersions;
dropping the dispersions into the polymer-stabilized cholesteric liquid crystal mixture;
dropping a few drops of the solvent into the mixture and stirring well;
heating the mixture for homogenization and then removing the solvent; and
injecting the mixture into an ITO cell and polymerizing a polymer network.

9. The liquid crystal display device of claim 1, wherein the contrast of the liquid crystal display device is 60.0% and above.

10. The liquid crystal display device of claim 1, wherein the response time of the liquid crystal display device is 30 ms and below.
